(19) United States
(12) Patent Application Publication
(10) Pub. No.: US 2019/0370706 A1
(43) Pub. Date: Dec. 5, 2019

(54) System And Method Of Managing Inspection Nonconformances

(71) Applicant: Edward Caldeira, Crofton, MD (US)

(72) Inventor: Edward Caldeira, Crofton, MD (US)

(21) Appl. No.: 16/000,681

(22) Filed: Jun. 5, 2018

(51) Int. Cl. G06Q 10/06; G06Q 10/08

(52) U.S. Cl. CPC G06Q 10/06; G06Q 10/087

(57) ABSTRACT

A system for managing inspection nonconformances is provided. The system comprises a processor, a memory, and a nonconformance management application stored in the memory. When executed on the processor, the application observes that an inspection checkpoint rated during an inspection has been marked as nonconforming. The application also creates a nonconformance record and associates the record with the checkpoint, the record describing a nonconformance found at the checkpoint. The application also assigns responsibility for correction of the nonconformance to a responsible party. The application also sets a due date for correction of the nonconformance and subsequently receives documentation of correction activity in the nonconformance record.

### CROSS REFERENCE TO RELATED APPLICATIONS

The present nonprovisional patent application is related to U.S. provisional application 62/515,768 filed Jun. 6, 2017.

### FIELD OF THE DISCLOSURE

The present disclosure is in the technical field of quality control. More particularly, the present disclosure provides systems and methods of documenting ad resolving nonconformances during inspections using nonconformance records incorporated into inspection documents.

### BACKGROUND OF THE DISCLOSURE

Inspections of commercial and residential buildings and other structures involve rating many individual points of inspection within and around the structures. When an individual checkpoint does not pass inspection, its resolution may delay overall passing of inspection. Purchase and occupation may be delayed by inspection failures when the building is a subject of a transaction. Such inspection failures are referred to herein as nonconformances, wherein workmanship or another aspect of the checkpoint's satisfactory completion has not met a predefined or expected standard or benchmark.

Nonconformances have previously been managed separately and independently from inspections. Two separate and unrelated systems result from this unnatural division. The inspection system does not have visibility into the nonconformance system and cannot track progress of problem resolution. The nonconformance system does not have accountability to, accessibility into, or even communication with the inspection system.

By contrast, attempting to merge the inspection and nonconformance processes into a single monolithic document creates a cumbersome and unwieldy file that may reveal more information than is necessary for some viewers to see. It may expose confidential information about proprietary construction methods or the number and extent of quality issues. The reputation of general or subcontractor may be adversely impacted. A party performing remedial work on a limited aspect of a construction project should not be provided access to information about areas of the project to which the party's remedial work is not related.

Attempts to solve these problems by independently documenting each nonconformance and merely linking them to the inspection report forces authorized readers to go back and forth between inspection report and documentation of the nonconformance. In many cases, inspection reports do not describe nonconformances and merely show a subject checkpoint as having been rated as failed with no explanation. It cannot be determined from viewing such an inspection report if any or all of the nonconformances have been resolved. Merely linking an independently prepared nonconformance document to an inspection report does not address the problem.

### SUMMARY OF THE DISCLOSURE

In an embodiment, a system for managing inspection nonconformances is provided. The system comprises a processor, a memory, and a nonconformance management application stored in the memory, that when executed on the processor, observes that an inspection checkpoint rated during an inspection has been marked as nonconforming. The system also creates a nonconformance record and associates the record with the checkpoint, the record describing a nonconformance found at the checkpoint. The system also assigns responsibility for correction of the nonconformance to a responsible party and sets a due date for correction of the nonconformance. The system also subsequently receives documentation of correction activity in the nonconformance record.

### BRIEF DESCRIPTION OF THE DRAWINGS

FIG. 1 is a block diagram of a system of managing inspection nonconformances according to an embodiment of the present disclosure.

FIG. 2 is an image of a graphical user interface describing a method of managing inspection nonconformances in accordance with an embodiment of the present disclosure.

### DETAILED DESCRIPTION OF THE INVENTION

Systems and methods provided herein enable problems found during building inspections to be identified and described with central recording of remedial actions and communications. Clear accountability is assigned and tracked and resolution history is thoroughly documented and supported. Inspections of physical structures, such as commercial buildings, apartment buildings and other multifamily structures, and single family homes embody many individual checkpoints, points of inspection wherein the subject item receives either a pass or fail rating. A rating of fail may be referred to as a nonconformance, as one or more aspects of the checkpoint does not conform to a predetermined qualitative and/or qualitative standard.

In many cases a nonconformance may prevent overall inspection of the structure to receive a rating of pass until the nonconformance is resolved. Nonconformance may consist of a failure to meet a professionally or legally mandated standard, for example wiring or plumbing code. Nonconformance may additionally or alternatively comprise failure to meet a subjective, cosmetic, or aesthetic level or standard of workmanship.

When inspection of an individual checkpoint results in a nonconformance, a nonconformance record is created. The record is permanently associated with the individual checkpoint and made part of the overall inspection report containing the individual checkpoint and many other checkpoints. The nonconformance record is incorporated into cannot be removed from the inspection record. The nonconformance record can always be found in the future by locating the inspection report. A permanent history is therefore created if for any reason problems or questions arise years or even decades later with the subject inspected structure. The permanent record of accountability is created and stored such that parties are protected from liability when appropriate or may be held accountable as the case may be.

The nonconformance record is the single point of documentation and record keeping for the particular nonconformance. Any document with relevance to the nonconformance and its resolution is contained within or permanently referenced by the nonconformance record. In particular, correspondence between parties involved including contractors, inspectors, bonding companies, and parties responsible for investigating and resolving the nonconformance is included. The record also contains an area for involved parties to enter notes and remarks. All information related to the nonconformance is contained in the nonconformance record. The record documents the full sequence of events toward resolution including communications between parties.

In embodiments, two or more nonconformances may be related to each other either at the same inspection checkpoint or at different checkpoints. Nonconformance records for each such related nonconformance contain references to the other whether the related nonconformances are at the same or different inspection checkpoints.

In some cases, dependencies may exist among related nonconformances such that full resolution of one nonconformance may be dependent upon full or partial resolution of a second nonconformance or dependent upon at least some action or communication associated with the second nonconformance. Dependencies may exist between nonconformances at the same or different inspection points. The attribute of nonconformance recording described herein providing for thorough recording of communication may be of particular value in such dependency situations when responsible parties may depend on each other to execute certain tasks before other tasks may be completed or even undertaken.

In an embodiment, access to nonconformance records within inspection reports may be limited to specific parties as such inspection reports may contain proprietary information or trade secrets of a contractor involved in the project. In such cases, some information may not be viewable by all parties to the nonconformance matter.

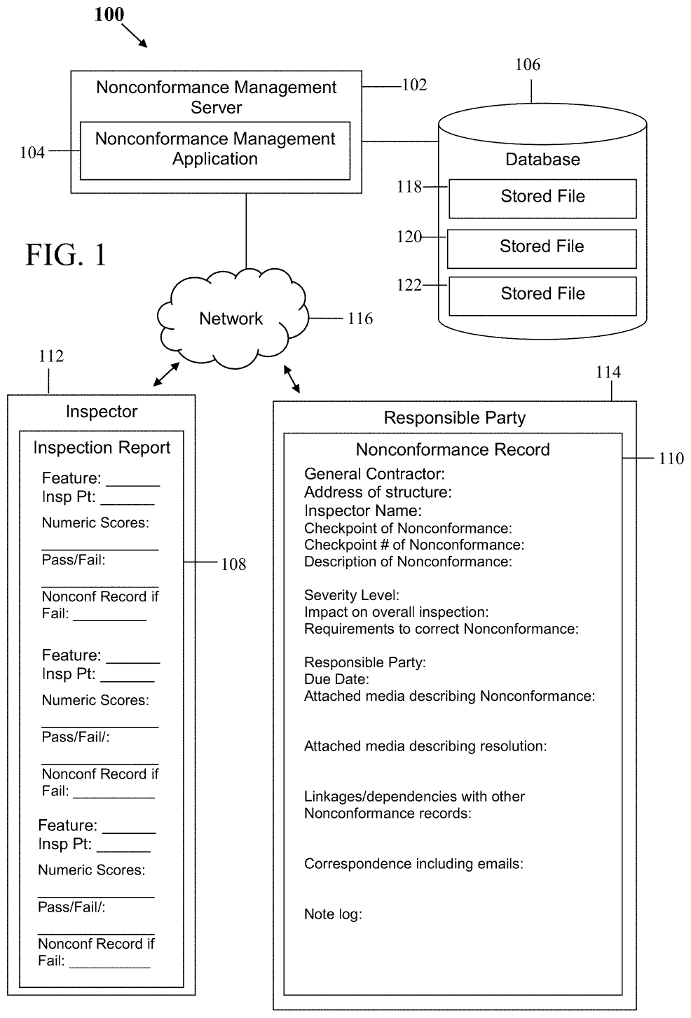

Turning to the figures, FIG. 1 is a block diagram of a system of managing nonconformances in accordance with an embodiment of the present disclosure. FIG. 1 depicts components of a system 100 provided herein. System 100 comprises a nonconformance management server 102, a nonconformance management application 104, a database 106, an inspection report 108, a nonconformance record 110, an inspector 112, a responsible party 114, a network 116, and stored records 118, 120, 122.

While only one each of inspection report 108 and nonconformance record 110 is depicted in FIG. 1, in most embodiments a plurality of each of inspection report 108 and nonconformance record 110 are provided by the system 100 and in effect. In the interest of brevity, the nonconformance management server 102 and the nonconformance management application 104 may be referred to as the server 102 and the application 104, respectively.

The server 102 is a computer system. In embodiment, functionality of the server 102 is handled by more than one computer system. The computer system may feature computer hardware, network devices and communication hardware and software that is specific to the systems and methods provided herein.

The application 104 executes on the server 102 and creates a nonconformance record 110 when an inspection checkpoint in an inspection report 108 is marked as nonconforming or failing. In an embodiment, the nonconformance record 110 is automatically created when an inspector notes in an inspection report 108 that an inspection checkpoint is nonconforming. In an embodiment, the nonconformance record 110 is created manually. In yet another embodiment, the nonconformance record 110 is created automatically and may be overridden or cancelled by inspectors or others with requisite authority.

The inspection report 108 depicted in FIG. 1 contains areas for three separate checkpoints to be rated. Features are areas within which individual checkpoints are located. In a residential structure, for example a single family home, a feature may be a bathroom. Within the feature one checkpoint may be water pressure in the shower and a second checkpoint may be sturdiness of attachment of a bathroom mirror to the bathroom wall. In an office building, a feature may be the seventh floor corridor and a checkpoint within the feature may be quality of installation of carpet within that particular corridor. In an actual inspection, the inspection report 108 would contain many features and many inspection points within features.

Inspection reports 108, features, checkpoints and how inspection reports are created and managed are described in detail in U.S. patent application Ser. No. 15/896,169 entitled System And Method Of Generating Inspection Checklists, filed Feb. 14, 2018, the contents of which are incorporated by reference herein.

FIG. 1 depicts only one nonconformance record 110 and it is provided as only a sample. In embodiments, the nonconformance record 110 may be structured in manners different than as depicted, may contain different fields for information entry and may be incorporated into inspection report 108 in various ways. Nonconformance record 110 may effectively be an electronic folder providing for storage of media of various types to document the nonconformance as well as document steps toward resolution. Text files, spreadsheets, still photographs, video files and audio files are examples of the types of media that may be included in or attached to a nonconformance record 110.

The nonconformance record 110, once created, is incorporated into and becomes a permanent part of the inspection report 108. Within the inspection report 108, at least at the particular checkpoint where the nonconformance was found, the contents of the nonconformance record 110 are visible and in some cases editable by authorized parties. The contents include records of communications, including electronic mail messages, between the responsible party 114, the inspector 112, and others.

The responsible party 114 is the party charged with resolving the nonconformance. In some cases, the responsible party 114 may be a subcontractor that performed the work found to be in nonconformance. In other cases, the responsible party 114 may be a different party, possibly one with expertise in correcting construction problems, whether related to plumbing, electrical work, landscaping, or some other aspect of construction. In some cases, multiple responsible parties 114 may be involved in a single nonconformance with responsibilities for each clearly documented in the nonconformance record 110 from the outset.

The nonconformance record 110 is depicted in FIG. 1 as inside the responsible party 114 and the inspection report 108 is similarly depicted as inside the inspector 110. This depiction is provided to indicate these parties' responsibilities for handling these documents. In most embodiments, the inspector 108 and the responsible party 114 would be using mobile devices such as tablet computers to make their entries. Their entries would then be sent wirelessly through the network 116 to the server 102 where the application 104 would update a master file containing the inspection report 108 and its component nonconformance records 110 stored on the server 102.

The database 106 is associated with the server 102 and contains stored files 118, 120, 122 of closed inspection reports 108 and incorporated nonconformance records 110. Such stored files 118, 120, 122 may contain other documents and media related to closed matters.

The application 104 may in some aspects work in concert with a checklist creation application that executes on a checklist creation server, components that are not depicted in FIG. 1. The application 104, upon noting that, or receiving advice that, a checkpoint in the inspection has not passed inspection as is therefore the subject of a nonconformance, creates the nonconformance record 110. The application 104 may automatically populate some fields of the nonconformance record 110. The inspector 112 populates other fields such as description of the nonconformance and the specific actions required for resolution. The inspector 112 may designate the responsible party 114 and due date for resolution. In embodiments, this information may be automatically determined and populated into the nonconformance record 110.

The network 116 is a wired and/or wireless public and/or private network through which the components of system 100 communicate with each other and with components not shown in FIG. 1. While the database 106 is depicted in FIG. 1 as directly connected to the server 102, in embodiments the database 106 communicates with the server 102 and perhaps other components not illustrated via the network 116 or via other indirect means.

Systems and methods provide further embodiments for the nonconformance management application 104 to evaluate electronic material received including nonconformance records 110, evaluate the material, and make recommendations or full rulings for overall pass or fail or otherwise provide advice about an overall inspection. In some cases, inspectors 112 may electronically capture checkpoint data and submit it for analysis by the application 104. These actions may supplement full visual and other inspection activities by inspectors 112 where the inspector 112 may make a ruling about a nonconformance or where the inspector 112 may merely capture information about a checkpoint and submit the information to the application 104 and the application 104 makes a recommendation about a nonconformance.

In embodiments, inspectors 112 may conduct inspections of many checkpoints in a very rapid fashion wherein the inspectors 112 may merely capture data about checkpoints and electronically submit the data to the application 104 for a decision or recommendation by the application 104 about conformance or nonconformance at particular checkpoints as well as pass or fail on the overall inspection. In these embodiments, inspectors 112 may be carrying handheld electronic devices that capture checkpoint information about electronically available data such as voltage.

The inspectors 112 may be required to move quickly through this area of inspections such that the inspectors 112 capture data quickly, submit the data electronically via wireless connection, and move on rapidly to the next checkpoint without evaluating the captured data. The application 104 executing on the nonconformance management server 102, which is likely distant from the jobsite of the inspection, receives the captured data. The application 104 then makes evaluations and recommendations about conformance at particular checkpoints in these embodiments.

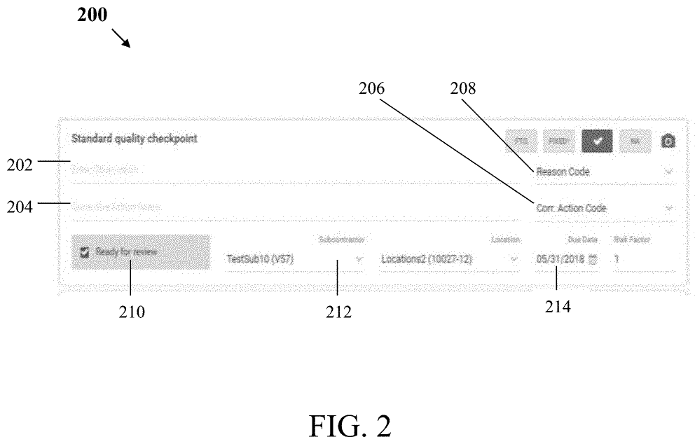

FIG. 2 is an image of a graphical user interface supporting a method in accordance with an embodiment of the present disclosure. FIG. 2 depicts a standard quality checkpoint interface 200, henceforth interface 200, provided by nonconformance management application 104 of the system 100. The interface 200 functions as a checkpoint record between open status and fixed or resolved status for a nonconformance.

The interface 200 provides a means for the party responsible for correcting a nonconformance to report that the nonconformance has been addressed, and is ready for the inspector 112 to review and approve or reject the correction. If accepted the inspector 12 changes the status to corrected (Fixed). The inspector may alternatively reject the remedial work performed by unchecking ready for review. All information in the interface 200 would become a permanent part of the inspection report 108 and the nonconformance record 110 as described elsewhere herein.

FIG. 2 includes a field 202 for Enter Observation and a field 204 for Corrective Action Notes where the correcting party would describe what work had been done to address the nonconformance. Item 206 is for entry of a Corrective Action Code and item 208 is for entry of a Reason Code. Item 210 is a button or icon that would be activated to indicate Ready To Review such that the inspector 112 would visit the site and review the remedied nonconformance. Item 212 is for entry of subcontractor information and item 214 is for entry of the date of the action.

What is claimed is:

1. A system for managing inspection nonconformances, comprising:
a processor;
a memory; and
a nonconformance management application stored in the memory, that when executed on the processor:
observes that an inspection checkpoint rated during an inspection has been marked as nonconforming;
creates a nonconformance record and associates the record with the checkpoint, the record describing a nonconformance found at the checkpoint;
assigns responsibility for correction of the nonconformance to a responsible party;
sets a due date for correction of the nonconformance; and
subsequently receives documentation of correction activity in the nonconformance record.

2. The system of claim 1, wherein the inspection checkpoint is an individual rateable aspect of an overall inspection of a physical structure.

3. The system of claim 1, wherein the nonconformance comprises a failure to meet at least one quality standard previously set for the checkpoint.

4. The system of claim 1, wherein during and upon completion of correction of the nonconformance, the responsible party enters correction activity into the nonconformance record and marks the record as complete when appropriate.

5. The system of claim 4, wherein the nonconformance management application, upon noting that the nonconformance record has been marked as complete, sends a notification of the reported completion to an inspector associated with the inspection.

6. The system of claim 5, wherein the inspector, based on receiving the notification, assesses the correction activity and one of approves and closes the nonconformance record and rejects the correction activity and communicates the assessment to the responsible party.

7. The system of claim 4, wherein the at least one of the nonconformance, the requirements for correction, and the correction activity are described in the nonconformance record using at least one of text, photographic, video and audio formats.

8. The system of claim 1, wherein association of the nonconformance record with the checkpoint comprises incorporating the nonconformance record into a checklist containing the checkpoint among a plurality of checkpoints, the checklist covering the overall inspection.

9. The system of claim 1, wherein the nonconformance record remains permanently incorporated into the checklist and at the checkpoint at which the nonconformance was found.

10. The system of claim 1, wherein the nonconformance record contains a record of correspondence between parties and activities associated with the nonconformance.

11. A method for managing inspection nonconformances, comprising:
a computer observing that an inspection checkpoint rated during an inspection has been marked as nonconforming;
the computer creating a nonconformance record and associating the record with the checkpoint, the record describing a nonconformance found at the checkpoint;
the computer assigning responsibility for correction of the nonconformance to a responsible party;
the computer setting a due date for correction of the nonconformance; and
the computer subsequently receiving documentation of correction activity in the nonconformance record.

12. The method of claim 11, wherein the inspection checkpoint is an individual rateable aspect of an overall inspection of a physical structure.

13. The method of claim 11, wherein the nonconformance comprises a failure to meet at least one quality standard previously set for the checkpoint.

14. The method of claim 1, further comprising during and upon completion of correction of the nonconformance, the responsible party entering correction activity into the nonconformance record and marking the record as complete when appropriate.

15. The method of claim 14, further comprising the nonconformance management application, upon noting that the nonconformance record has been marked as complete, sending a notification of the reported completion to an inspector associated with the inspection.

16. The method of claim 15, further comprising the inspector, based on receiving the notification, assessing the correction activity and one of approving and closing the nonconformance record and rejecting the correction activity and communicating the assessment to the responsible party.

17. A method for managing inspection nonconformances, comprising:
a computer receiving and storing a nonconformance record describing an inspection nonconformance at a checkpoint of an overall inspection of a physical structure;
the computer evaluating the nonconformance record;
the computer recommending, based on at least the evaluation, that the overall inspection receive of rating of failed;
the computer associating received electronic documents with the stored nonconformance record, the documents describing work directed to resolving the inspection nonconformance; and
the computer recommending, based at least on analysis of the received documents, that the rating of the overall inspection be changed to passed.

18. The method of claim 17, wherein the electronic documents are permanently associated with the nonconformance record.

19. The method of claim 17, wherein the nonconformance record is permanently associated with records of the overall inspection.

20. The method of claim 17, wherein the electronic documents comprise at least correspondence among parties comprising at least builders, inspectors, subcontractors.
